(19) United States
(12) Patent Application Publication
(10) Pub. No.: US 2023/0149985 A1
(43) Pub. Date: May 18, 2023

(54) DRAIN AUGER

(71) Applicant: TECHTRONIC CORDLESS GP, Anderson, SC (US)

(72) Inventors: Brianna E. Williams, Mauldin, SC (US); Justin Meyer, Anderson, SC (US); Maverick Larkin, Anderson, SC (US)

(21) Appl. No.: 18/053,872

(22) Filed: Nov. 9, 2022

Related U.S. Application Data
(60) Provisional application No. 63/278,881, filed on Nov. 12, 2021.

(51) Int. Cl. B08B 9/045; E03C 1/302

(52) U.S. Cl. CPC B08B 9/045; E03C 1/302; B08B 2209/04

(57) ABSTRACT

The present disclosure provides a drain auger than includes a drum with an accessory attachment. A pole attachment is coupled to the drum. A cable is extendable and retractable relative to the drum. An actuator is operatively coupled to the cable and a motor is operably coupled to the actuator. A mode selector is coupled to the drum and includes an auto-feed mode. The auto-feed mode is configured to selectively and automatically extend and retract the cable relative to the drum in response to actuation of the actuator.

### CROSS-REFERENCE TO RELATED APPLICATIONS

The following application claims priority to co-pending U.S. Provisional Patent Application No. 63/278,881, filed on Nov. 12, 2021, the entire content of which is incorporated herein by reference.

### FIELD

The present subject matter relates to a drain auger and, more specifically, to a handheld drain auger.

### BACKGROUND

The field of drain augers varies widely from hand-held drain augers used by a homeowner to unclog toilets, sinks, bathtubs, and other household drains, and those commercially available drain augers often used by plumbers. Some household drain augers require a separate drill that is coupled to the drum of the drain auger to advance and retract the cable. Other drain augers capable of addressing more difficult clogs require a separate power source and have an electrical cord to receive power from a wall outlet, which can cause electrical hazards in areas where water is present. These and other drain augers often have an exposed cable that is handled by the operator as the cable is fed from the drum into the drain and rewound in the drum, resulting in unsanitary conditions for the user.

### SUMMARY

The present disclosure provides, in one aspect, a drain auger including a drum, a pole attachment, an actuator, a motor, and a mode selector. The drum includes an accessory attachment and a cable extendable and retractable relative to the drum. The pole attachment is couplable to the drum. The actuator is operatively coupled to the cable. The motor is operably coupled to the actuator and to the cable. The mode selector is coupled to the drum and includes an auto-feed mode to selectively and automatically extend and retract the cable relative to the drum in response to actuation of the actuator.

In other embodiments, the mode selector includes a spin mode to selectively and automatically spin the cable, and may be a separate mode from the auto-feed mode.

The present disclosure provides, in another aspect, a drain auger including a drum, a housing, and a mode selector. The drum includes a cable that is extendable and retractable relative to the drum. The housing is coupled to the drum and supports an actuator operatively coupled to the cable. The housing further supports a motor unit and a battery. The mode selector is coupled to the drum and includes one or both of an auto-feed mode and a spin mode. The auto-feed mode is configured to selectively and automatically extend and retract the cable relative to the drum in response to actuation of the actuator. The spin mode is configured to selectively and automatically spin the cable in response to actuation of the actuator.

In some embodiments, a foot pedal is coupled to the drum and operably coupled to the cable to extend and retract the cable, or to spin the cable based on a setting of the mode selector.

The present disclosure provides, in another aspect, a drain auger including a drum, a housing, and a mode selector. The drum includes an accessory attachment configured to support a replaceable first tip. The drum also includes a cable that is extendable and retractable relative to the drum. The cable includes a replaceable second tip. The housing is coupled to the drum and supports an actuator that is operatively coupled to the cable. The mode selector is coupled to the drum and includes one or both of an auto-feed mode and a spin mode. The auto-feed mode is configured to selectively and automatically extend and retract the cable relative to the drum in response to actuation of the actuator. The spin mode is configured to selectively and automatically spin the cable in response to actuation of the actuator. The mode selector is disposed on or adjacent the accessory attachment.

Other aspects of the present subject matter will become apparent by consideration of the detailed description and accompanying drawings.

### BRIEF DESCRIPTION OF THE DRAWINGS

FIG. 1a is a side view illustrating a motor unit and drum of an exemplary drain auger.

FIG. 1b is a perspective view of a motor unit according to FIG. 1a.

FIG. 1c is side view illustrating an exemplary drain auger.

FIG. 1d is a perspective view of a drain auger according to FIG. 1c, illustrating the drain auger in use.

FIG. 2a is a side view illustrating a housing of another exemplary drain auger embodying the invention.

FIG. 2b is a side view illustrating an exemplary drain auger according to FIG. 2a, including the pole attachment.

FIG. 2c is a perspective view illustrating the exemplary drain auger according to FIG. 2b, as shown in use.

FIG. 3a is a side view illustrating a housing of another exemplary drain auger, including additional accessories.

FIG. 3b is a perspective view of a bucket of an exemplary drain auger according to FIG. 3a, the bucket being used with a plumbing system.

FIG. 3c is a side view illustrating the exemplary drain auger according to FIG. 3a, including a pole attachment.

FIG. 3d is a perspective view illustrating a cable brush of the exemplary drain auger according to FIG. 3a.

FIG. 3e is a perspective view illustrating the exemplary drain auger according to FIG. 3a, as shown in use.

FIG. 4a is a perspective view illustrating another exemplary drain auger according to the present invention, with additional accessories.

FIG. 4b is a perspective view illustrating a cable brush according to the exemplary drain auger of FIG. 4a.

FIG. 4c is a section view illustrating the drum of the drain auger according to FIG. 4a, illustrating cleaning of the drum and cable.

### DETAILED DESCRIPTION

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways.

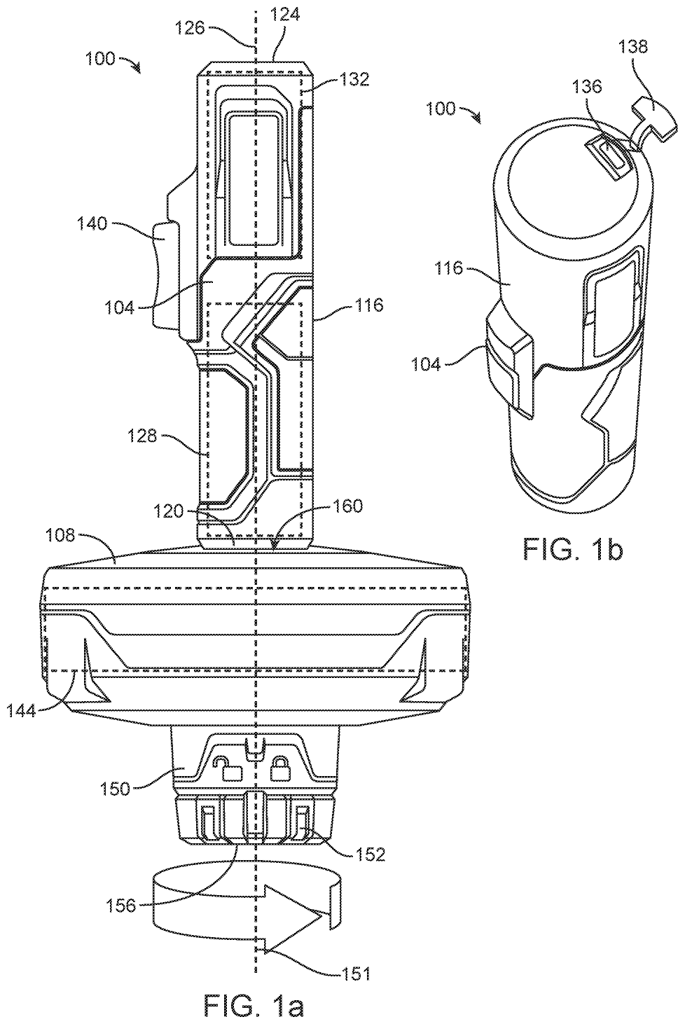

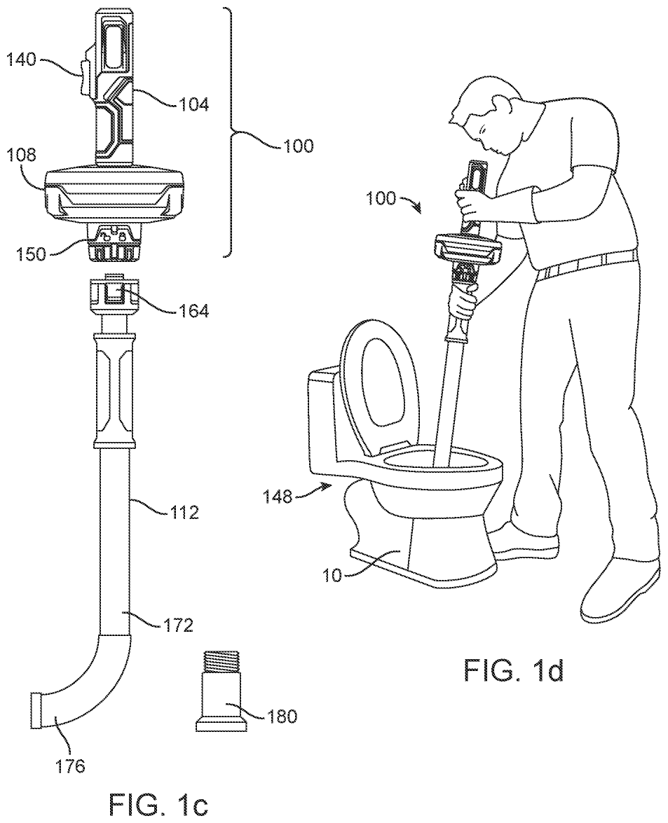

FIGS. 1a-1d illustrate an exemplary drain auger 100 including a motor unit 104, a drum 108, and a pole attachment 112. The illustrated drain auger 100 takes the form of a snake-type auger, although the drain auger 100 may take other forms without deviating from the scope of the disclosure. The motor unit 104 has a housing 116 that defines a handle or grip for the drain auger 100 extending from a first end 120 to a second or distal end 124 along a housing axis 126. The housing 116 supports a motor 128 and a battery 132 (e.g., a 12v battery, a 4V battery, and/or the like) that is rechargeable (e.g., the battery 132 is integrated into the housing 116). The motor unit 104 is removably attached to the drum 108 (e.g., to recharge the battery 132 away from the drum 108), and the first end 120 is coupled to the drum 108. A charge port 136 is located on or adjacent the second end 124 to electrically couple the battery 132 to an external power source while the motor unit 104 is connected to or disconnected from the drum 108. As shown in FIG. 1b, a cover 138 may be removably coupled to the charge port 136 (e.g., to inhibit ingress of debris or fluid). As best shown in FIGS. 1a and 1c, the motor unit 104 has a throttle or actuator 140 that is disposed between the first end 120 and the second end 124. It will be appreciated that the actuator 140 may be located anywhere on the motor unit 104.

The drum 108 supports or has a cable 144 that is circumferentially wound therein and that can extend into and retract from the drum 108 relative to a plumbing system 148 (e.g., a toilet 10, a drain, etc.). It will be appreciated that the plumbing system 148 may be any type of system that has piping and that may need cleaning or unclogging. The actuator 140 can be engaged by a user to control extension and retraction of the cable 144 relative to the plumbing system 148. As shown in FIG. 1a, the drum 108 includes an accessory attachment 150 that defines an accessory axis 151 and that supports a mode selector or feed control 152 to facilitate user selection of an auto-feed mode or a spin mode. As shown, the mode selector 152 is disposed on a cable outlet 156 of the drum 108 that is opposite a motor attachment 160 that operably couples the drum 108 to the motor unit 104. With reference to FIG. 1a, the illustrated mode selector 152 is rotatable between the auto-feed mode and the spin mode, although other actuation between modes are possible and considered herein. As shown in FIGS. 1a, 1c, the accessory attachment 150 and the handle of the housing 116 are coaxially aligned (e.g., the housing axis 126 and the accessory axis 151 are in line with each other).

In the auto-feed mode, the cable 144 may extend into or retract from the plumbing system 148 based on engagement of the actuator 140. For example, pushing forward on the actuator 140 (toward the first end 120) may extend the cable 144, and pushing backward on the actuator 140 (toward the second end 124) may retract the cable 144. In the spin mode (e.g., a cable lock mode in which the cable 144 cannot extend or retract), the cable 144 may rotate without extension or retraction based on engagement of the actuator 140. For example, pushing forward on the actuator 140 (toward the first end 120) may rotate the cable 144 clockwise without extension or retraction, and pushing backward on the actuator 140 (toward the second end 124) may rotate the cable 144 counter-clockwise without extension or retraction. In an embodiment, the cable 144 may only spin in one rotational direction (e.g., clockwise but not counter-clockwise, or counter-clockwise but not clockwise). In some constructions, the cable 144 may rotate in combination with extension or retraction of the cable 144. It will be appreciated that the actuator 140 may take other forms (e.g., a toggle switch, a lever, etc.). When the motor unit 104 is attached to the drum 108, the motor 128 is operably coupled to the cable 144 to extend, retract, or spin the cable 144 based on user engagement of the actuator 140 and a selected mode of the drum 108.

The pole attachment 112 is removably coupled to the accessory attachment 150 (e.g., via a threaded or snap-fit arrangement). In some embodiments, when the pole attachment 112 is coupled to the accessory attachment 150, the mode selector 152 may be covered by the pole attachment 112 and the auto-feed mode or the spin mode may be selected prior to attachment of the pole attachment 112 to the accessory attachment 150. In an embodiment, the pole attachment 112 may arranged in a manner (e.g., inside the cable outlet 156) that permits selection of the auto-feed mode and the spin mode without removal of the pole attachment 112 from the accessory attachment 150. Different attachments may be removably coupled to a tip end 172 of the pole attachment 112 depending on the system 148 with which the drain auger 100 is used. For example, the attachment may include a first tip or a toilet tip 176 that is defined by a curved cylindrical connector for insertion into a toilet 10 of the plumbing system 148. In another non-limiting example, the attachment may be a second tip or urinal tip 180 that is defined by straight cylindrical connector for insertion into a urinal of the plumbing system 148. The toilet tip 176 and the urinal tip 180 may be interchangeably coupled to the pole attachment 112. The attachments may be disposable or reusable, and may be formed of a resilient material such as rubber. In some embodiments, the attachment may have a diameter corresponding to the pipe diameter in which the attachment is used, or taper from the diameter of the pole attachment 112 to a smaller or larger diameter (e.g., suitable for use of the drain auger 100 with the plumbing system 148).

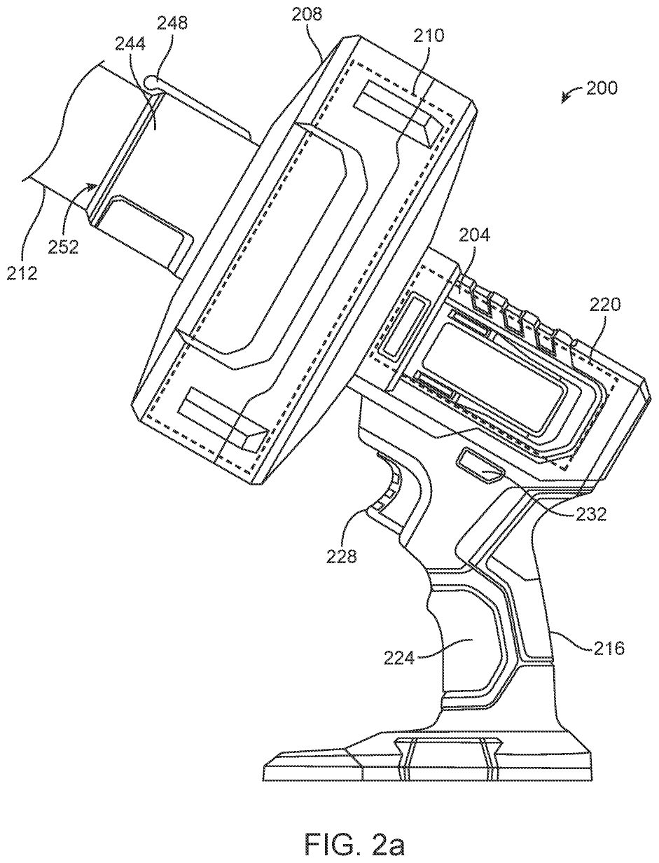

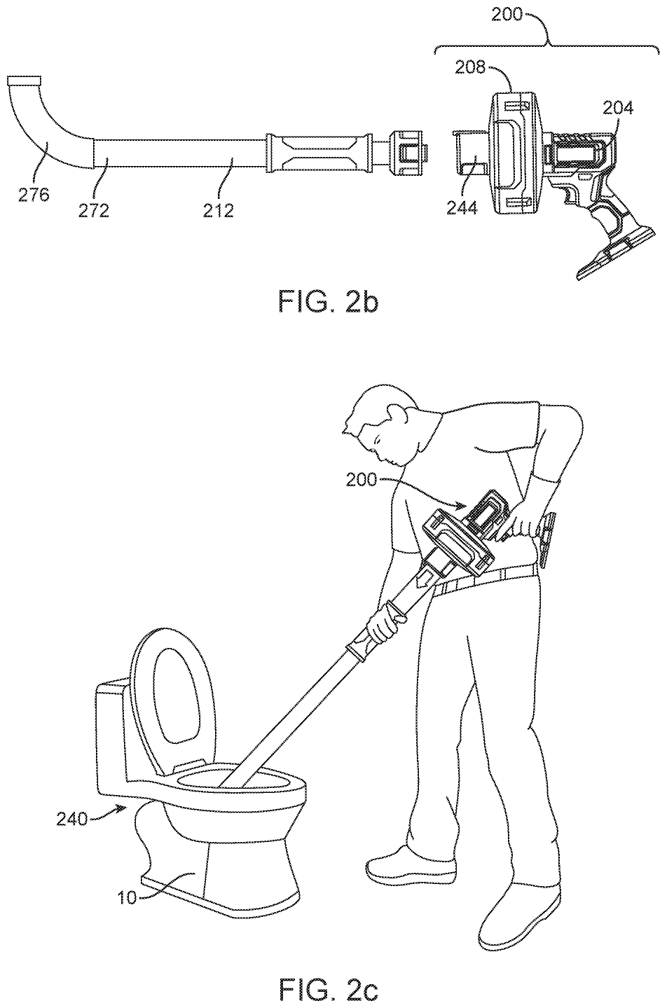

FIGS. 2a-2c illustrate another exemplary drain auger 200 including a motor portion or motor unit 204, a drum 208 that supports or has a cable 210, and a pole attachment 212. The pole attachment 212 may be removably coupled to the drum 208. The motor unit 204 includes a housing 216 that supports a motor 220. As shown, the drum 208 and the housing 216 may be at least partially co-molded as shown in FIG. 2a, or the drum 208 and the housing 216 may be coupled to each other by fasteners or other mechanisms. In some constructions, the drum 208 may be removably coupled to the housing 216.

A handle 224 (e.g., a pistol grip) extends from the motor unit 204 and a battery pack (e.g., an 18v battery pack, a 40v battery pack, and/or the like) may be removably coupled to a distal end of the handle 224 to power the motor unit 204. A throttle or actuator 228 (e.g., a trigger switch) and a direction selector 232 are coupled to the handle 224 adjacent the motor unit 204. As illustrated, the actuator 228 is depressible by a user to operably engage the cable 210. In some embodiments, the actuator 228 may operate the motor unit 204 at different speeds (e.g., based on the amount that the actuator 228 is pulled by a user). The direction selector 232 may take the form of a movable or slidable switch that is accessible from opposite sides of the handle 224. For example, a user may press the direction selector 232 in one direction (e.g., illustrated as into the page in FIG. 2a) to select an extend state so that the cable 210 extends out of the drum 208 when the actuator 228 is engaged, and a user may press the direction selector 232 in the opposite direction (e.g., illustrated as out of the page in FIG. 2a) to select a retract state so that the cable 210 retracts into the drum 208. In some embodiments, the direction selector 232 may be a pressable switch engaged by the user to retract the cable 210 when the actuator 228 is engaged, and release of the direction selector 232 extends the cable 210 outward when the actuator 228 is engaged. It will be appreciated that the actuator 228 and the direction selector 232 may take other forms.

The cable 210 is circumferentially wound inside the drum 208 and can extend into and retract from the drum 208 relative to a plumbing system 240 (e.g., a toilet 10, a drain, etc.). The actuator 228, the direction selector 232, and the cable 210 are operably coupled to the motor unit 204 to control movement of the cable 210. The actuator 228 and the direction selector 232 are engaged by a user to control extension and retraction of the cable 210 from the drum 208 as well as spin of the cable 210 based on the mode selected.

As shown in FIG. 2a, the drum 208 includes an accessory attachment 244 to which the pole attachment 212 may be removably coupled (e.g., via a snap-fit arrangement). The accessory attachment 244 supports a mode selector or feed control 248 to facilitate user selection of an auto-feed mode or a spin mode (e.g., a cable lock mode in which the cable 210 cannot extend or retract). As shown, the mode selector 248 is disposed on a cable outlet 252 of the drum 208 that is opposite the motor unit 204. In some embodiments, the mode selector 248 may be supported by the motor unit 204 or elsewhere on the drain auger 200. In some embodiments, when the pole attachment 212 is coupled to the accessory attachment 244, the mode selector 248 may be covered by the pole attachment 212 and the auto-feed mode or the spin mode may be selected prior to attachment of the pole attachment 212 to the accessory attachment 244. In an embodiment, the pole attachment 212 may be arranged in a manner (e.g., inside the cable outlet 252) that permits selection of the auto-feed mode and the spin mode without removal of the pole attachment 212 from the accessory attachment 244.

In the auto-feed mode, the cable 210 may extend into or retract from the plumbing system 240 based on engagement of the actuator 228 and the position or state of the direction selector 232. For example, the direction selector 232 may be placed in the extend state or the retract state (as desired by the user) and depressing the actuator 228 extends or retracts the cable 210 relative to the drum based on the state selected for the direction selector. In the spin mode, selected via the mode selector 248, the cable 210 may rotate without extension or retraction based on depression of the actuator 228. For example, placing the mode selector 248 in the spin mode may disengage the direction selector 232 from the cable 210 such that on actuation of the actuator 228, the cable 210 only rotates or spins in one direction without extension or retraction of the cable 210 relative to the drum 208. In another example, the cable 210 may spin or rotate in the clockwise direction or the counter-clockwise direction in response to actuation of the actuator 228 based on the state selected for the direction selector 232 when the mode selector 248 is in the spin mode. In yet another non-limiting example, the cable 210 may rotate in combination with extension or retraction of the cable 210.

With reference to FIGS. 2b and 2c, different attachments may be removably coupled to a tip end 272 of the pole attachment 212 depending on the plumbing system 240 with which the drain auger 200 is used. The attachment may include a toilet tip 276 (e.g., similar to or the same as the toilet tip 176) that is defined by a curved cylindrical connector for insertion into the toilet 10 of the plumbing system 240. In another non-limiting example, the attachment may be a urinal tip (e.g., similar to or the same as urinal tip 180) that is defined by a straight cylindrical connector for insertion into the urinal of a plumbing system 240. The toilet tip 276 and the urinal tip may be interchangeably coupled to the pole attachment 212. The attachment may be disposable or reusable, and may be formed of a resilient material such as rubber. The attachment may take other forms (e.g., tapered, curved, angled, etc.) depending on the system 240 with which it is used.

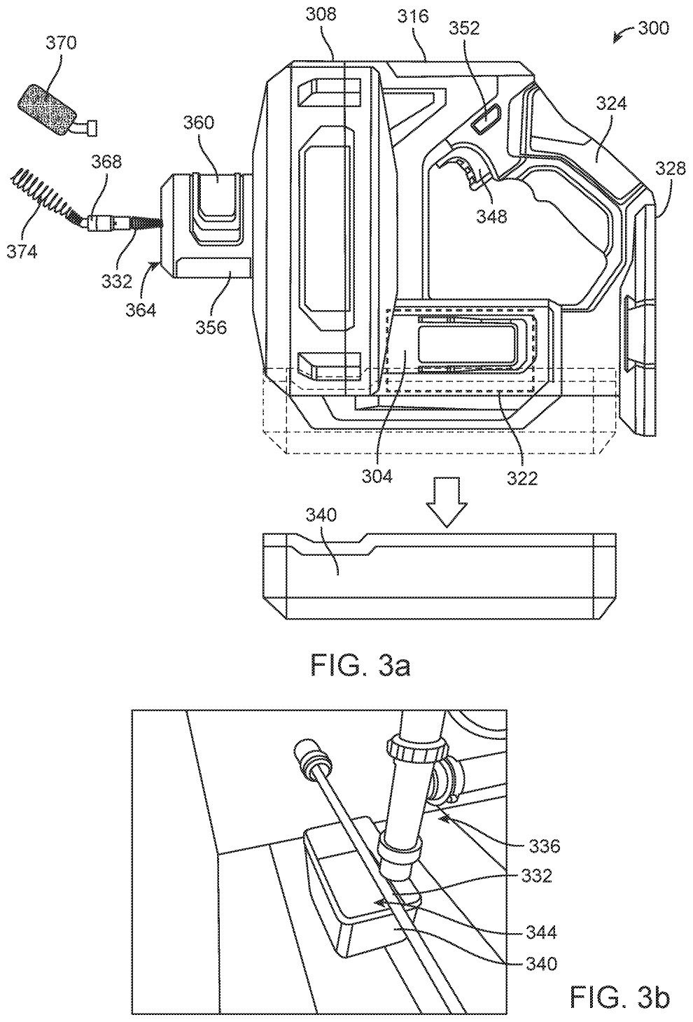

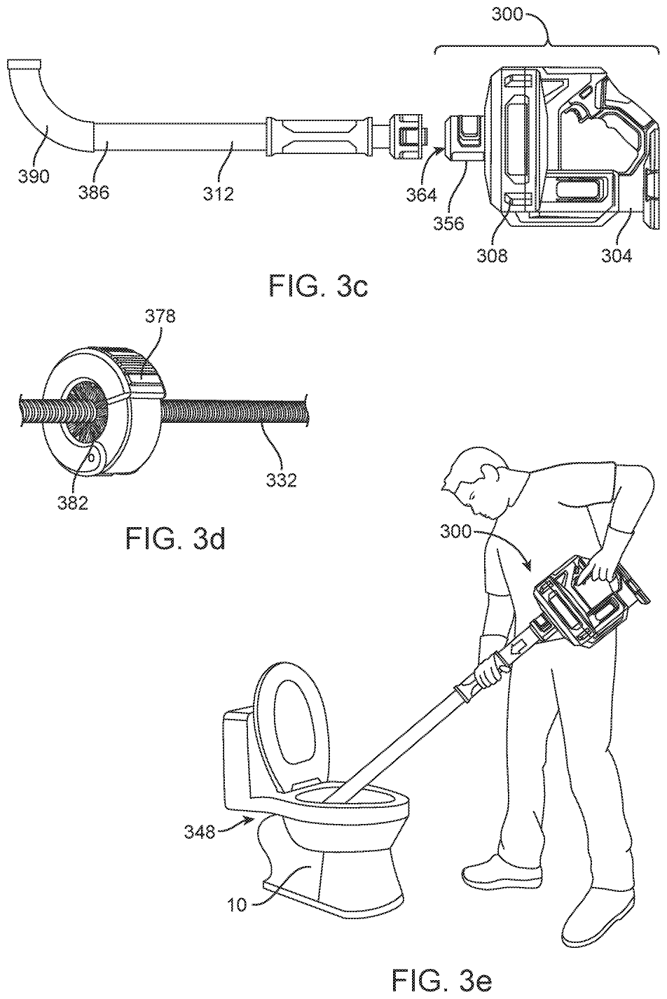

FIGS. 3a-3e illustrate another exemplary drain auger 300 including a motor unit 304, a drum 308, and a pole attachment 312. The pole attachment 312 may be removably coupled to the drum 308 (e.g., via a snap-fit arrangement). A housing 316 supports the motor unit 304, which has a motor 322, and includes a handle 324. The handle 324 extends from the drum 308 above the motor unit 304 (as viewed in FIG. 3a) and joins with the motor unit 304 at a battery attachment 328. The battery attachment 328 supports a battery pack (e.g., an 18v rechargeable battery pack) that may be removably coupled to the drain auger 300 to power the motor unit 304. The drum 308 and the housing 316 may be at least partially co-molded. In some embodiments, the drum 308 may be removably coupled to the housing 316 (e.g., via fasteners or other mechanisms. The drum 308 supports or has a cable 332 (e.g., a cable having a length of about thirty feet) that is circumferentially wound therein and can extend into and retract relative to a plumbing system 336 (e.g., a drainage pipe for a sink, or another plumbing system). In some embodiments, a spigot may be formed in the drum 308 to fluidly communicate with an interior of the drum 308 to introduce a fluid into the drum 308 (e.g., to clean the interior of the drum 308 and the cable 332). In some embodiments, the drum 308 may have a drain and fluidly communicates the interior of the drum 308 to drain debris and fluid therefrom.

As shown in FIGS. 3a and 3b, a bucket or container 340 is removably coupled to one or both of the motor unit 304 and the drum 308 (e.g., via press fit, snap fit, fasteners, and/or the like). The bucket 340 defines a cavity 344 into which water or other material from the plumbing system 336 can be drained during use of the auger 300. In this way, a plumbing procedure may be rendered more efficient as having a built-in bucket or container 340 may obviate the need for a user to carry around an additional, larger and/or bulkier bucket or container.

Returning to FIG. 3a, the handle 324 supports a throttle or actuator 348 (e.g., a trigger switch) and a direction selector 352. In some embodiments, the actuator 348 and direction selector 352 may be supported elsewhere on the housing 316. As illustrated, the actuator 348 is depressible by a user to operably engage the cable 332. In some embodiments, the actuator 348 may operate the motor unit 304 at different speeds (e.g., based on the amount that the actuator 348 is pulled by a user). The direction selector 352 may take the form of a movable or slidable switch that is accessible from opposite sides of the handle 324. For example, a user may press the direction selector 352 in one direction (e.g., illustrated as into the page in FIG. 3a) to select an extend state so that the cable 332 extends out of the drum 308 when the actuator 348 is engaged, and a user may press the direction selector 352 in the opposite direction (e.g., illustrated as out of the page in FIG. 3a) to select a retract state so that the cable 332 retracts into the drum 308. In some embodiments, the direction selector 352 may be a pressable switch engaged by the user to retract the cable 332 when the actuator 348 is engaged, and release of the direction selector 352 extends the cable 332 outward when the actuator 348 is engaged. It will be appreciated that the actuator 348 may take other forms (e.g., a toggle switch, a lever, etc.), and that the direction selector 352 may take other forms (e.g., a button, a toggle switch, etc.).

The drum 308 includes an accessory attachment 356 to which the pole attachment 312 may be coupled. The accessory attachment 356 supports a mode selector or feed control 360 to facilitate user selection of an auto-feed mode or a spin mode (e.g., a cable lock mode in which the cable 332 cannot extend or retract). As shown, the mode selector 360 is disposed on a cable outlet 364 of the drum 308. In some embodiments, the mode selector 360 may be supported by the motor unit 304 or elsewhere on the drain auger 300. In some embodiments, when the pole attachment 312 is coupled to the accessory attachment 356, the mode selector 360 may be covered by the pole attachment 312 and the auto-feed mode or the spin mode may be selected prior to attachment of the pole attachment 312 to the accessory attachment 356. In an embodiment, the pole attachment 312 may be arranged in a manner (e.g., inside the cable outlet 364) that permits selection of the auto-feed mode and the spin mode without removal of the pole attachment 312 from the accessory attachment 356.

In the auto-feed mode, the cable 332 may extend into or retract relative to the drum 308 and the plumbing system 336 based on engagement of the actuator 348 and the position or state of the direction selector 352. For example, the direction selector 352 may be placed in the extend state or the retract state (as desired by the user) and depressing the actuator 348 extends or retracts the cable 332 relative to the drum based on the state selected for the direction selector. In the spin mode, selected via the mode selector 360, the cable 332 may rotate without extension or retraction based on depression of the actuator 348. For example, placing the mode selector 360 in the spin mode may disengage the direction selector 352 from the cable 332 such that on actuation of the actuator 348, the cable 332 only rotates or spins in one direction without extension or retraction of the cable 332 relative to the drum 308. In another example, the cable 332 may spin or rotate in the clockwise direction or the counter-clockwise direction in response to actuation of the actuator 348 based on the state selected for the direction selector 352 when the mode selector 360 is in the spin mode. In yet another non-limiting example, the cable 332 may rotate in combination with extension or retraction of the cable 332.

With reference to FIG. 3a, the auger 300 includes removable and replaceable cable tips for selection of a tip that is suitable for the task. For example, the cable 332 may include a cable tip 368 that is replaceable with other cable tips, such as a disposable coconut husk tip 370 or an angled wire tip 374. Other types of tips may be coupled to the cable 332 and are considered herein. All such tips may be removable and interchangeable with other tips.

With reference to FIG. 3d, the auger 300 may include a cleaning brush 378 that has a plurality of bristles 382. The cleaning brush 378 may be removably coupled to the cable outlet 364 and may be arranged concentric with the cable 332. The cleaning brush 378 may be locked onto the cable outlet 364 so that bristles 382 of the cleaning brush 378 engage the cable 332 to remove debris as the cable 332 is retracted into the drum 308. In this way, a plumbing procedure may be rendered more sanitary as the user may not have to touch such debris as it is retracted from a plumbing system. In some embodiments, the cleaning brush 378 is integrated with the cable outlet 364. In some embodiments, the cleaning brush 378 may be an accessory that is attachable to the cable 332 or the cable outlet 364 after a plumbing procedure.

The pole attachment 312 (e.g., a pole attachment with a diameter of approximately two inches) is removably coupled to the cable outlet 364. Different attachments may be removably coupled to the pole attachment 312 at a tip end 386. The attachments may be disposable or reusable (e.g., formed of a resilient material such as rubber). The attachment may be a toilet tip 390 that defines a curved cylindrical connector for insertion into a toilet 10 of the plumbing system 336. The attachment instead may be a urinal tip (e.g., similar to or the same as urinal tip 180) that defines a straight cylindrical connector for insertion into a urinal of a plumbing system 336. The toilet tip 390 and urinal tip may be interchangeably coupled to the pole attachment 312. The attachment may take other geometric forms configured to correspond to the plumbing system 336.

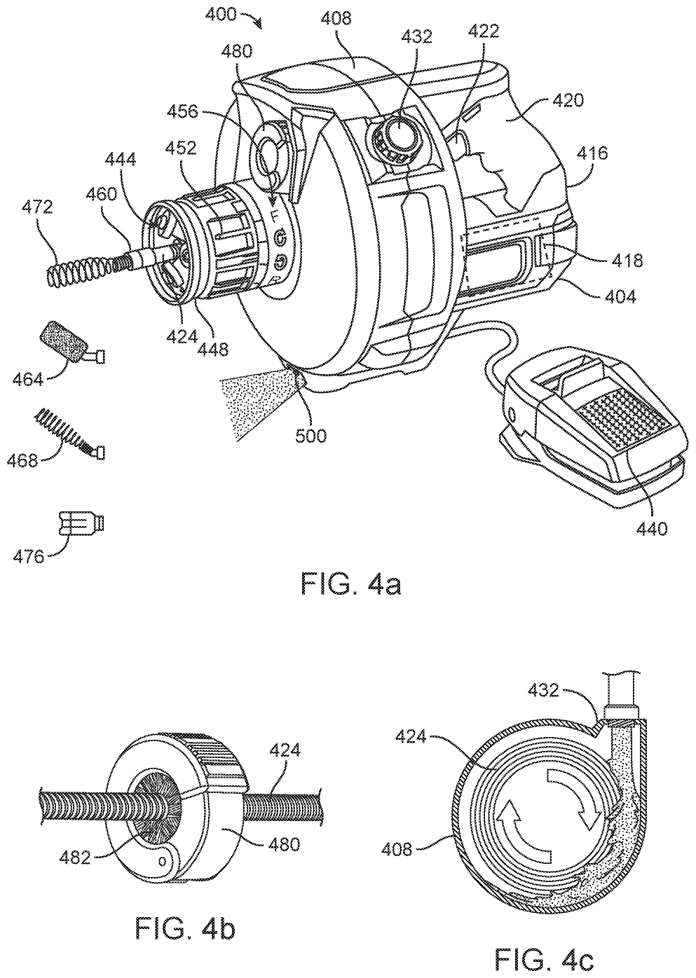

FIGS. 4a-4c illustrate another exemplary drain auger 400 including a motor unit 404 and a drum 408. A housing 416 supports the motor unit 404, which includes a motor 418. The housing 416 includes a handle 420 that supports a first actuator 422 extends from the drum 408 above the motor unit 404 and joins the motor unit 404 at a distal end of the motor unit 404. The first actuator 422 is the same as the actuator 348 described with regard to the auger 300 of FIGS. 3a-3e. In some embodiments, the drum 408 and the housing 416 are at least partially co-molded. In other embodiments, the drum 408 is removably coupled to the housing 416. A rechargeable battery (e.g., an 18v battery pack) may be removably coupled to the housing 416 to power the motor unit 404. The drum 408 supports or has a cable 424 (e.g., a reinforced metal core cable having a length of about fifty feet) that is circumferentially wound therein and can extend into, retract from, or spin within a plumbing system (e.g., a drainage pipe for a sink, toilet 10, urinal, or other fluid system). The motor unit 404 is operably coupled to the cable 424 for extending the cable 424 into, retracting the cable 424 from, or spinning the cable 424 (e.g., within a plumbing system).

As shown in FIGS. 4a and 4c, the drum 408 includes a spigot 432 on the drum 408 that fluidly communicates with an interior of the drum 408 to introduce water or other cleaning fluid into the drum 408 (e.g., for cleaning the drum 408 and/or the cable 424). In this way, a plumbing procedure may be rendered more sanitary, as the drum 408 and/or cable 424 may be flushed and/or cleaned after performing the plumbing procedure. The drum 408 may also include a port or drain that fluidly communicates with the interior of the drum 408 for draining liquid and/or debris from the drum 408 (e.g., the drain may be located diametrically opposite the spigot 432). It will be appreciated that the spigot 432 and drain are separate openings into the drum 408, although the spigot 432 may be used to introduce and remove fluid and other material relative to the drum 408 in some embodiments.

Returning to FIG. 4a, the drain auger 400 includes a second or remote actuator 440 that is electrically coupled (e.g., via a cord) to the motor unit 404 to control extension, retraction, and/or spinning of the cable 424. As illustrated, the actuator 440 is a foot pedal that is depressible by a user to operably engage the cable 424. In some embodiments, the actuator 440 may operate the motor unit 404 at different speeds (e.g., based on the amount that the actuator 440 is depressed by a user), and may be wirelessly connected to the motor unit 404.

The drum 408 includes a cable outlet 444 with an accessory attachment 448 to which a pole attachment (similar to or the same as pole attachments 112, 212, 312) that may be removably coupled to the drum 408 (e.g., via snap-fit arrangement). The accessory attachment 448 supports a mode selector or feed control 452 (e.g., a rotatable selector) to facilitate user selection of an auto-feed mode or a spin mode (e.g., a cable lock mode in which the cable 424 cannot extend or retract) and direction of operation of the auto-feed mode or spin mode. As shown, the mode selector 452 is disposed on the cable outlet 444 of the drum 408. In some embodiments, the mode selector 452 may be supported by the motor unit 404 or elsewhere on the drain auger 400. In some embodiments, when the pole attachment is coupled to the accessory attachment 448, the mode selector 452 may be covered by the pole attachment and the auto-feed mode or the spin mode may be selected prior to attachment of the pole attachment to the accessory attachment 448. In an embodiment, the pole attachment may be arranged in a manner (e.g., inside the cable outlet 444) that permits selection of the auto-feed mode and the spin mode without removal of the pole attachment from the accessory attachment 448.

The mode selector 452 is rotatable by the user to select the mode and direction in which the drain auger 400 operates. In the illustrated example, the mode selector 452 is rotatable between first state that corresponds to a forward or extension direction of the auto-feed mode (e.g., extension of the cable 424 from the drum 408), a second state that corresponds to a reverse or retraction direction of the auto-feed mode (e.g., retraction of the cable 424 into the drum 408), a third state that corresponds to a counter-clockwise spin direction of the spin mode, and a fourth state that corresponds to a clockwise spin direction of the spin mode. Each of these states are indicated by indicators 456 located adjacent the mode selector 452 (e.g., adjacent the drum 408). In the auto-feed mode, the cable 424 extends into or retracts from the plumbing system based on rotatable selection of the forward direction or reverse direction by the mode selector 452 and actuation of the actuator 440. For example, selection of the forward direction by the mode selector 452 extends the cable 424 into the plumbing system, and selection of the reverse direction by the mode selector 452 retracts the cable 424 from the plumbing system. In the spin mode, the cable 424 only rotates in a clockwise or counterclockwise direction without extension or retraction (e.g., a lock mode) based on selection of the clockwise or counterclockwise direction of the spin mode and engagement of the actuator 440. For example, selection of the clockwise spin direction will spin the cable 424 in a clockwise direction and selection of the counterclockwise spin direction will spin the cable 424 in the counterclockwise direction. In an embodiment, the cable 424 may only spin in one rotational direction. In some constructions, the cable 424 may rotate in combination with extension or retraction of the cable 424.

The drain auger 400 includes removable and replaceable cable tips for selection of a tip that is suitable for the task. For example, the cable 424 may include a cable tip 460 that is replaceable with other cable tips, such as a disposable coconut husk tip 464, an angled wire tip 468, a spiral tip 472, or an endoscope 476 that provides video (e.g., via Bluetooth, near field communication (NFC), etc.) to a phone or other viewing device. Other types of tips (e.g., a spigot drum cleanout, an integrated brush, an integrated cleaning brush, and/or the like) may be coupled to the cable 424 and are considered herein. All such tips may be removable and interchangeable with other tips, and some or all tips may be disposable (e.g., recyclable or designed for one-use).

With reference to FIG. 4b, the auger 400 may include a cleaning brush 480 that has a plurality of bristles 482. The cleaning brush 480 may be removably coupled to the cable outlet 444 and may be arranged concentric with the cable 424. The cleaning brush 480 may be locked onto the cable outlet 444 so that bristles 482 of the cleaning brush 480 engage the cable 424 to remove debris as the cable 424 is retracted into the drum 408. In some embodiments, the cleaning brush 480 is integrated with the cable outlet 444. In some embodiments, the cleaning brush 480 may be an accessory that is attachable to the cable 424 or the cable outlet 444 after a plumbing procedure. In some embodiments, the cleaning brush 480 may be storable on the auger 400 (e.g., on the drum 408).

Different attachments may be removably coupled to the auger 400 or the pole attachment 112, 212, 312. The attachments may be disposable or reusable (e.g., formed of a resilient material such as rubber). The attachment may be a toilet tip (e.g., toilet tip 390) that defines a curved cylindrical connector for insertion into a toilet of the plumbing system. The attachment instead may be a urinal tip (e.g., urinal tip 180) that defines a straight cylindrical connector for insertion into a urinal of a plumbing system. The toilet tip and urinal tip may be interchangeably coupled to the pole attachment. The attachment may take other geometric forms configured to correspond to the plumbing system.

With reference to FIG. 4a, the drum 408 may support one or more light sources 500 (e.g., one or more LED lights) that is directed outward from the drum 408 to illuminate the surrounding workspace. In some embodiments, the light source 500 may be directed to another surrounding space for illuminating the work area, or the light source 500 may be aimable/movable. The light source 500 may be any source of illumination and may be supported on any part of the drain auger 400.

Any of the above-disclosed exemplary drain augers may be operable with or without a pole attachment, and other attachments may be coupled to the pole attachment (e.g., a non-removable tip) or directly to the accessory attachment 448.

Any of the above-disclosed exemplary drain augers 100, 200, 300, 400 may include a light source supported by the drum or the housing that may be directed toward the cable outlet or surrounding workspace for providing illumination of the plumbing system. It will also be appreciated that the drain augers 100, 200, 300, 400 of the present disclosure may include different features and combinations of features disclosed in any of the different embodiments.

As can be understood from the figures illustrating the embodiments of the present disclosure, the attachment pole and other aspects of the disclosure provide the user the ability to work in a removed position, that is, at a distance, from a plumbing system.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A drain auger comprising:
a drum including an accessory attachment
a cable disposed in the drum, the cable being extendable and retractable relative to the drum;
a pole attachment coupled to the drum;
an actuator operatively coupled to the cable;
a motor operably coupled to the actuator; and
a mode selector coupled to the drum and including an auto-feed mode configured to selectively and automatically extend and retract the cable relative to the drum in response to actuation of the actuator.

2. The drain auger of claim 1, wherein the mode selector further includes a spin mode configured to selectively and automatically spin the cable in response to actuation of the actuator.

3. The drain auger of claim 2, wherein the spin mode is separate from the auto-feed mode.

4. The drain auger of claim 1, further comprising a housing defining a handle supporting the actuator, wherein the housing is coupled to the drum.

5. The drain auger of claim 4, wherein the drum has an accessory attachment to which the pole attachment is coupled, and wherein the accessory attachment and the handle are coaxially aligned.

6. The drain auger of claim 4, wherein the housing is removably attached to the drum.

7. The drain auger of claim 4, wherein the housing supports a rechargeable battery.

8. The drain auger of claim 7, wherein the battery is removable from the housing.

9. The drain auger of claim 1, wherein the pole attachment includes a first tip coupled to an end of the pole attachment opposite the attachment of the pole attachment to the drum, and wherein the first tip is removable and replaceable with a second tip.

10. The drain auger of claim 9, wherein the first tip is a toilet tip or a urinal tip and the second tip is the other of the urinal tip or the toilet tip.

11. The drain auger of claim 1, wherein the cable includes a first tip comprising a spiral tip, a disposable tip, an angled tip, an integrated brush, a spigot drum cleanout, or an endoscope, and wherein the first tip is replaceable with a second tip comprising a spiral tip, a disposable tip, an angled tip, an integrated brush, a spigot drum cleanout, or an endoscope.

12. The drain auger of claim 1, wherein the cable includes an integrated cleaning brush.

13. The drain auger of claim 1, further comprising a housing coupled to the drum and a bucket removably attached to one or both of the drum and the housing.

14. A drain auger comprising:
a drum including a cable that is extendable and retractable relative to the drum;
a housing coupled to the drum and supporting an actuator operatively coupled to the cable, the housing further supporting a motor unit and a battery; and
a mode selector coupled to the drum and including one or both of an auto-feed mode and a spin mode, the auto-feed mode configured to selectively and automatically extend and retract the cable relative to the drum in response to actuation of the actuator, and the spin mode configured to selectively and automatically spin the cable in response to actuation of the actuator.

15. The drain auger of claim 14, wherein the housing includes a handle and a motor portion separate from the handle, and wherein the actuator is coupled to the handle.

16. The drain auger of claim 14, further comprising a foot pedal operably coupled to the cable to extend or retract the cable, or to spin the cable based on a setting of the mode selector.

17. The drain auger of claim 14, wherein the drum includes an accessory attachment and the drain auger further comprises a pole attachment coupled to the drum at the accessory attachment.

18. The drain auger of claim 14, wherein the cable includes a first tip coupled to an end of the cable, and wherein the tip is replaceable with a second tip.

19. A drain auger comprising:
a drum including an accessory attachment configured to support a replaceable first tip, the drum further including a cable extendable and retractable relative to the drum, the cable including a replaceable second tip;
a housing coupled to the drum and supporting an actuator operatively coupled to the cable; and
a mode selector coupled to the drum and including one or both of an auto-feed mode and a spin mode, the auto-feed mode configured to selectively and automatically extend and retract the cable relative to the drum in response to actuation of the actuator, and the spin mode configured to selectively and automatically spin the cable in response to actuation of the actuator,
wherein the mode selector is disposed on or adjacent the accessory attachment.

20. The drain auger of claim 19, wherein the housing further supports a motor unit and a battery removable from the housing, and wherein the drum and the housing are at least partially co-molded.
